(19) United States
(12) Patent Application Publication
(10) Pub. No.: US 2025/0108874 A1
(43) Pub. Date: Apr. 3, 2025

(54) FRAME STRUCTURE

(71) Applicant: HONDA MOTOR CO., LTD., Tokyo (JP)

(72) Inventors: Hideyuki Matsuhashi, Wako-shi (JP); Kazuhiro Kudo, Wako-shi (JP); Takero Shibukawa, Wako-shi (JP); Takahide Konchi, Wako-shi (JP); Yuji Ushijima, Wako-shi (JP); Ichiro Tobisawa, Wako-shi (JP)

(21) Appl. No.: 18/892,929

(22) Filed: Sep. 23, 2024

(30) Foreign Application Priority Data
Sep. 29, 2023 (JP) 2023-169191

(51) Int. Cl. B62K 3/02; B62J 1/08; B62J 1/18

(52) U.S. Cl. CPC B62K 3/02; B62J 1/08; B62J 1/18

(57) ABSTRACT

This frame structure includes: a head pipe; a main frame extending rearward from the head pipe; and a seat frame disposed above the main frame and supporting a seat, wherein the seat frame includes a through hole that passes through a region within a front-rear width and a vertical width of the seat frame in a left-right direction in a side view, and wherein a grip portion that follows an upper edge of the through hole is formed in a flat shape extending in a front-rear direction.

### CROSS-REFERENCE TO RELATED APPLICATION

The present application claims priority based on Japanese Patent Application No. 2023-169191, filed Sep. 29, 2023, the content of which is incorporated herein by reference.

### BACKGROUND OF THE INVENTION

### Field of the Invention

The present invention relates to a frame structure.

### Description of Related Art

In the related art, there is a frame structure that includes a main frame extending rearward from a head pipe and a seat frame that is disposed above the main frame and supports a seat (see, for example, Japanese Unexamined Patent Application, First Publication No. 2004-001653).

### SUMMARY OF THE INVENTION

In the case of the bicycle described above, when a user who has dismounted from the bicycle lifts a vehicle body and carries the bicycle, frame members may be used as handles using a space formed between the frame members. In addition, for example, in the case of lightweight vehicles such as road bikes, a band made of leather or the like may be stretched between a down tube and a seat tube to serve as a handle.

However, with the above-mentioned measures, in the case of heavy vehicles such as electrically assisted vehicles and downhill bikes, a large load is put on the frame or band, and the burden on the hand of the user is also increased.

An aspect of the present invention has been made in consideration of the above circumstances and provides a frame structure that allows a user to easily lift a vehicle body and carry a vehicle.

In order to achieve the above object, a frame structure according to an aspect of the present invention employs the following configurations.

(1) A first aspect of the present invention includes: a head pipe; a main frame extending rearward from the head pipe; and a seat frame disposed above the main frame and supporting a seat, wherein the seat frame includes a through hole that passes through a region within a front-rear width and a vertical width of the seat frame in a left-right direction in a side view, and wherein a grip portion that follows an upper edge of the through hole is formed in a flat shape extending in a front-rear direction.

According to the above aspect (1), since the through hole is formed in the seat frame above the main frame and the grip portion that follows the upper edge of the through hole is formed in a flat shape extending in the front-rear direction, a handle for gripping the seat frame by placing the hand on the grip portion of the inner peripheral wall of the through hole can be formed in the seat frame. As a result, it is possible to make it easier to lift and carry equipment such as a vehicle to which the frame structure is applied. Since the inner peripheral wall that surrounds the hole internal space of the through hole over the entire periphery of the through hole is provided, the hole internal space is separated from the structural components around the seat frame, and the hand that passes through the through hole does not come into contact with the components around the frame and have its movement hindered, thereby making it easier to grip the seat frame and preventing the hand from getting dirty. The grip portion may not only have a flat surface, but may also have an uneven portion to make it easier to grip. In this case, the seat frame can be more easily gripped.

(2) In the above aspect (1), the grip portion may be formed in a plane shape extending in a vehicle width direction.

According to the above aspect (2), since the grip portion is formed in a plane shape extending in the vehicle width direction, even when a user places his or her fingers that have passed through the through hole on the grip portion to lift the seat frame, the burden on the fingers is curbed.

(3) The above aspect (2) may further include an inner peripheral wall surrounding a hole internal space of the through hole over the entire periphery of the through hole, wherein the inner peripheral wall may be formed by a peripheral wall rib extending in the left-right direction over the entire periphery of a peripheral edge of the through hole, and wherein a portion of the peripheral wall rib that forms the grip portion may be formed to be thicker than a portion of the peripheral wall rib that forms another portion.

According to the above aspect (3), since the portion of the peripheral wall rib that forms the grip portion is formed to be thick, it is possible to increase the strength and rigidity of the grip portion which is subjected to the greatest load when a user grips the upper portion of the seat frame to lift the vehicle. Since the portions that form the other portions except for the grip portion are formed to be thin, the weight of the seat frame can be reduced.

(4) In the above aspect (3), an inner peripheral rib that extends from the peripheral wall rib toward an inside of the through hole may be provided at a portion of the peripheral edge of the through hole other than the grip portion.

According to the above aspect (4), since the inner peripheral rib is provided in a portion of the through hole other than the grip portion, the strength and rigidity around the through hole can be increased while the impact on the hand is curbed when the hand is placed on the grip portion to grip the upper portion of the seat frame.

(5) The above aspect (3) or (4) may further include connecting ribs connecting the peripheral wall rib and frame outer peripheral ribs.

According to the above aspect (5), since the frame outer peripheral ribs that follow the outer peripheral edge of the seat frame and the peripheral wall rib that follows the peripheral edge of the through hole are connected by the connecting ribs, the peripheral wall rib can be reinforced and the strength and rigidity around the through hole can be increased.

(6) In the above aspect (5), the frame outer peripheral ribs may include a plurality of rib connecting portions that connect the connecting ribs, and the connecting ribs may connect the plurality of rib connecting portions of the frame outer peripheral ribs.

According to the above aspect (6), since a pair of the multiple rib connecting portions of the frame outer peripheral ribs are connected by the connecting ribs, the frame outer peripheral ribs can be reinforced, the strength and rigidity of the outer peripheral portion of the seat frame can be increased, and the strength and rigidity around the through hole can be increased.

(7) In the above aspect (6), the peripheral wall rib, the frame outer peripheral ribs, and the connecting ribs may extend in the left-right direction.

According to the above aspect (7), since each rib of the seat frame extends along the left-right direction, in a case in which the seat frame having the through hole in the left-right direction is formed by casting or forging, it is possible to easily form the seat frame by splitting the mold in the left-right direction while increasing the strength and rigidity of the seat frame.

(8) In the above aspect (1), the main frame may extend while having a hollow closed cross-sectional portion, and the seat frame may extend from the main frame while having an open cross-sectional portion that opens outward in the left-right direction.

According to the above aspect (8), since the main frame has the hollow closed cross-sectional portion and the seat frame has the open cross-sectional portion that opens outward in the left-right direction, it is possible to reduce the weight of the entire vehicle body frame. In addition, since the main frame has the closed cross-sectional portion, it is possible to ensure strength and rigidity. In addition, since the seat frame has the open cross-sectional portion, it is possible to achieve weight reduction and ease of manufacture. In addition, it is possible to ensure moderate strength and rigidity through the arrangement of the ribs.

(9) The above aspect (1) may further include a cover member for covering the seat frame from outside in the left-right direction.

According to the above aspect (9), since the seat frame is covered with the cover member from the outside in the left-right direction, it is possible to protect the seat frame and improve the appearance.

(10) In the above aspect (9), the cover member may include a cover through hole forming portion that forms a cover through hole that overlaps the through hole of the seat frame in a side view, and the cover through hole forming portion may include an inclined portion that is inclined from a side of the through hole of the seat frame toward an outer side surface of the cover member on an outer side in the left-right direction so as to be widened with respect to the through hole in a side view toward the outer side in the left-right direction.

According to the above aspect (10), since the cover through hole forming portion is provided with the inclined portion that is inclined so as to be widened with respect to the through hole toward the outer side in the left-right direction, when the hand is attempted to be placed into the through hole from the outside in the left-right direction, the hand is guided by the inclined portion, making it easier to pass the hand through the through hole, and making it easier to grip the upper portion of the seat frame.

(11) In the above aspect (9) or (10), the cover member may include a cover through hole forming portion that forms a cover through hole that overlaps the through hole of the seat frame in a side view, and the cover through hole forming portion may include an upper surface cover portion that covers the grip portion of the seat frame.

According to the above aspect (11), since the cover member of the seat frame covers the grip portion of the seat frame, in a case in which the seat frame is made of a metal and the cover member is made of a resin, the feeling on a side of the grip portion is softened, making it easier to grip the upper portion of the seat frame by placing the hand on a side of the grip portion.

(12) A second aspect of the present invention includes: a head pipe; a main frame extending rearward from the head pipe; a seat frame disposed above the main frame and supporting a seat; and a cover member for covering the seat frame from outside in a left-right direction, wherein the seat frame includes a through hole forming portion that forms a through hole that passes through a region within a front-rear width and a vertical width of the seat frame in a left-right direction in a side view, wherein the through hole forming portion includes an inner peripheral wall surrounding a hole internal space of the through hole over the entire periphery of the through hole, and wherein a grip portion of the inner peripheral wall that follows an upper edge of the through hole is formed in a flat shape extending in a front-rear direction by at least one of the seat frame and the cover member.

According to the above aspect (12), since the through hole is formed in the seat frame above the main frame and the grip portion that follows the upper edge of the through hole in the inner peripheral wall surrounding the hole internal space of the through hole is formed in a flat shape extending in the front-rear direction, a handle for gripping the seat frame by placing the hand on the grip portion of the inner wall of the through hole can be formed in the seat frame. As a result, it is possible to make it easier to lift and carry equipment such as a vehicle to which the frame structure is applied. Since the through hole forming portion has the inner peripheral wall that surrounds the hole internal space of the through hole over the entire periphery of the through hole, the hole internal space is separated from the structural components around the seat frame, and the hand that passes through the through hole does not come into contact with the components around the frame and have its movement hindered, thereby making it easier to grip the seat frame and preventing the hand from getting dirty. Since the grip portion of the inner peripheral wall is formed by at least one of the seat frame and the cover member, it is possible to more easily meet the requirements (the strength and rigidity, the appearance, the feeling, the ease of manufacture, and the like) required when a handle is provided.

According to an aspect of the present invention, it is possible to provide a frame structure that allows a user to easily lift a vehicle body and carry a vehicle.

### BRIEF DESCRIPTION OF THE DRAWINGS

FIG. 1 is a left side view of a bicycle to which a frame structure according to an embodiment of the present invention is applied.

FIG. 2 is a left side view of a vehicle body frame and a frame cover of the bicycle.

FIG. 3 is a left side view of the vehicle body frame.

FIG. 4 is a perspective view of a seat frame of the vehicle body frame and a seat frame cover portion of the frame cover as seen from below and rearward.

FIG. 5 is a perspective view of the seat frame as seen from below and rearward.

FIG. 6 is a cross-sectional view along line A-A of FIG. 2.

FIG. 7 is a cross-sectional view along line B-B of FIG. 3.

FIG. 8 is a cross-sectional view along line C-C of FIG. 3.

FIG. 9 is a cross-sectional view along line D-D of FIG. 3.

FIG. 10 is an explanatory diagram showing a state in which a user who has gripped the seat frame lifts the bicycle.

FIG. 11 is a cross-sectional view corresponding to FIG. 6, showing a modification example of the embodiment.

### DESCRIPTION OF EMBODIMENTS

Hereinafter, embodiments of the present invention will be described with reference to the drawings. Forward, rearward, left, and right directions in the following description are the same as directions in a vehicle, which will be described below, unless otherwise specified. Further, an arrow FR indicating a forward direction with respect to the vehicle, an arrow LH indicating a left direction with respect to the vehicle, an arrow UP indicating an upward direction with respect to the vehicle, and a line CL indicating a lateral center of a vehicle body are shown at appropriate places in the drawings used in the following description. The term “middle” used in the embodiment means not only the center between both ends of an object, but also an inner range between both ends of the object.

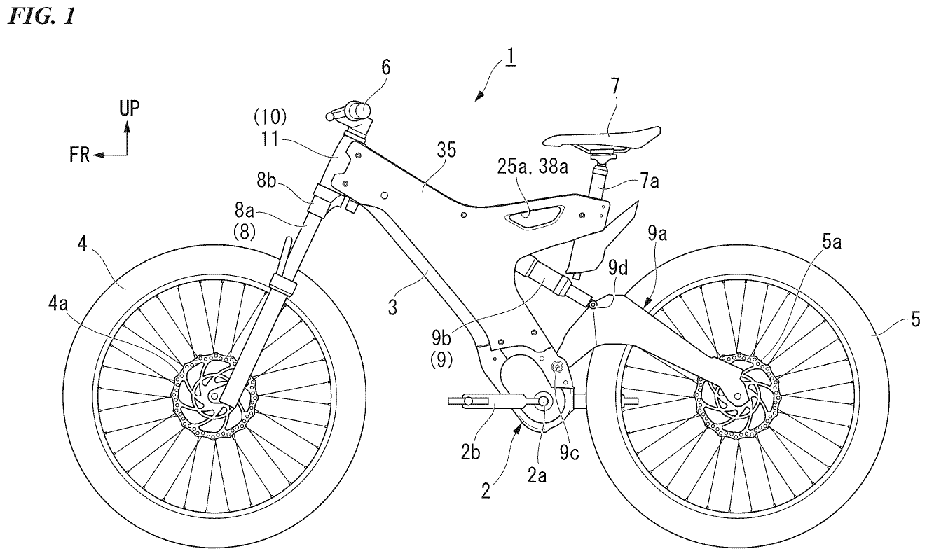

FIG. 1 is a left side view of a bicycle 1 as an example of a vehicle to which a frame structure according to an embodiment is applied. For example, the bicycle 1 is an electrically assisted bicycle that generates auxiliary power by an electric motor (an assist motor) in response to a tread force applied to pedals. In the bicycle 1, a drive unit 2 is mounted on the lower portion of a vehicle body frame 10, and a battery 3 is mounted along a main frame 12 extending rearward and downward from a head pipe 11 in the body frame 10. In addition, the drive unit 2 may be used as a prime mover for propelling the bicycle 1 using only motor output. In the figure, reference sign 4 denotes a front wheel, reference sign 5 denotes a rear wheel, reference sign 6 denotes a handlebar, and reference sign 7 denotes a seat.

For example, the bicycle 1 is used in a race to compete for time on an unpaved course. The front wheel 4 of the bicycle 1 is capable of absorbing shocks from the road surface by the operation of a front suspension 8. The rear wheel 5 of the bicycle is capable of absorbing shocks from the road surface by the operation of a rear suspension 9. The front suspension 8 includes, for example, a pair of left and right front forks 8a. The rear suspension 9 includes, for example, a single cushion unit 9b and a swing arm 9a. The bicycle is equipped with front and rear disc brakes 4a and 5a on the front and rear wheels 4 and 5, respectively.

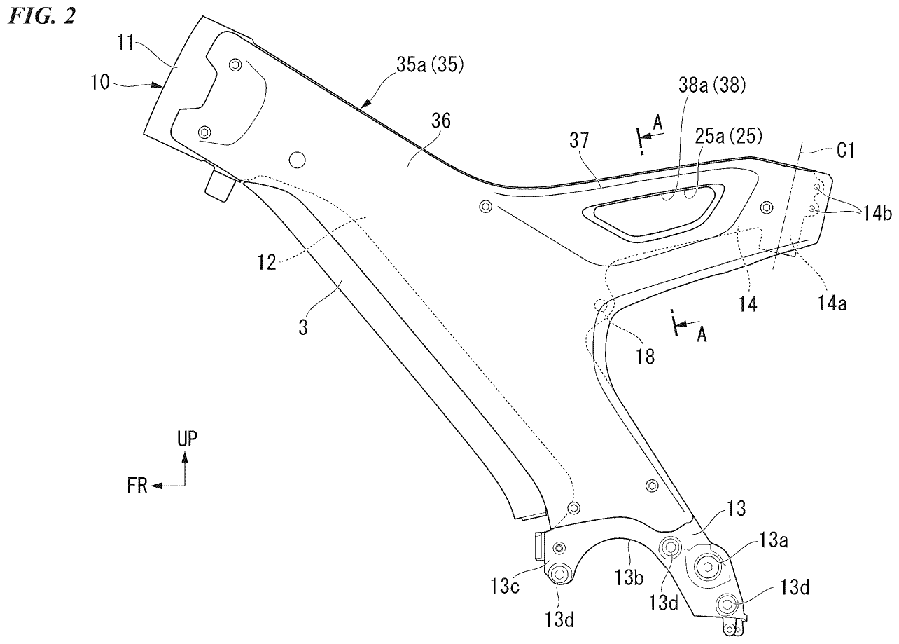

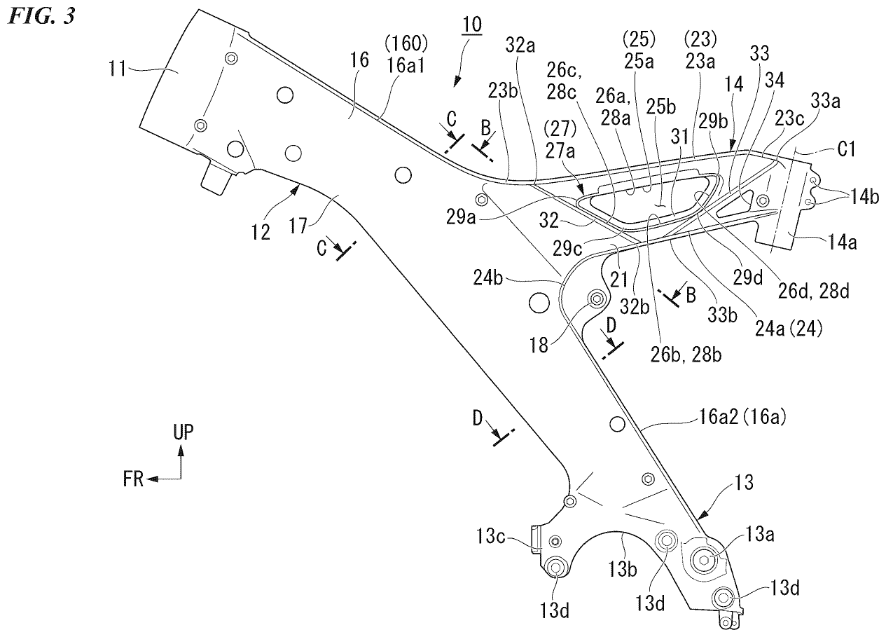

FIG. 2 is a left side view of the body frame 10 and a frame cover 35 of the bicycle 1, and FIG. 3 is a left side view of the vehicle body frame 10.

As shown in FIGS. 1 to 3, the vehicle body frame 10 of the bicycle 1 supports a large load by increasing the rigidity of the vehicle body frame 10, while the maneuverability of the vehicle body frame 10 is improved by providing partial flexibility to the vehicle body frame 10. The vehicle body frame 10 is made of, for example, an aluminum alloy, and both left and right sides of the vehicle body frame 10 are covered with the frame cover 35 made of a synthetic resin. The frame cover 35 constitutes a part of the frame structure of the embodiment.

The vehicle body frame 10 is formed by coupling a plurality of types of frame members together by welding, fastening, or the like. The vehicle body frame 10 includes a head pipe 11 located at the front end portion thereof, a main frame 12 that extends obliquely rearward and downward from the rear side of the head pipe 11, a pivot frame 13 that is connected to the rear lower end portion of the main frame 12, and a seat frame 14 that extends rearward and slightly upward from the upper side of the middle portion of the main frame 12 in a front-rear direction.

A stem pipe (not shown) is inserted into and rotatably supported by the head pipe 11. The lower end portion of the stem pipe protrudes below the head pipe 11, and a lower bracket 8b is attached to this lower end portion to be integrally rotatable therewith. The upper end portions of the left and right front forks 8a are supported by the lower bracket 8b. The front wheel 4 is supported by the lower end portions of the left and right front forks 8a. The upper end portion of the stem pipe protrudes above the head pipe 11, and the handlebar 6 is attached to this upper end portion to be integrally rotatable therewith.

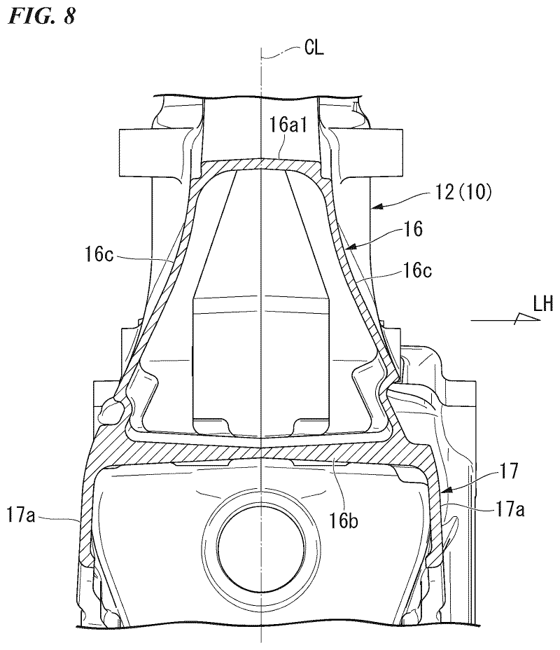

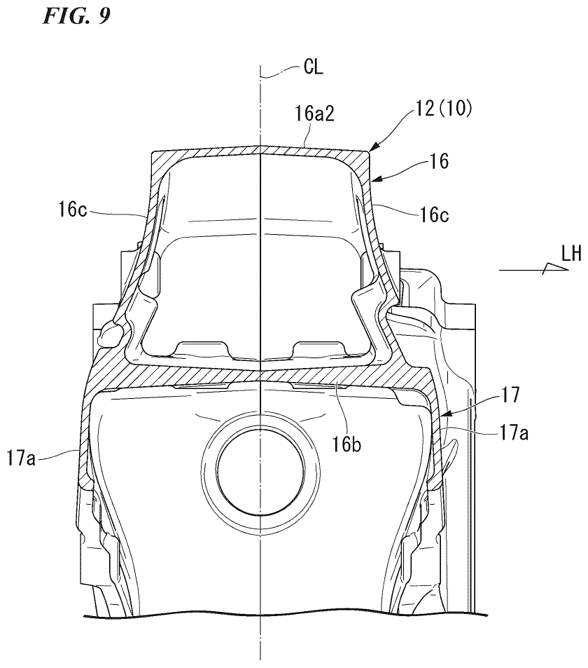

Referring also to FIGS. 8 and 9, the main frame 12 has a closed cross-sectional portion 16 that extends obliquely rearward and downward from the head pipe 11. The closed cross-sectional portion 16 has upper and lower walls and left and right side walls 16c and has a trapezoidal cross-sectional shape in which the lower wall 16b is wider in a left-right direction than the upper wall 16a. The closed cross-sectional portion 16 extends in the front-rear direction, thereby reducing the weight and increasing the rigidity of the main frame 12. In the closed cross-sectional portion 16, the upper wall 16a (a front upper wall 16a1) of a portion located in front of and above the seat frame 14 has a narrower left-right width than the upper wall 16a (a rear upper wall 16a2) of a portion located behind and below the seat frame 14.

The main frame 12 includes a pair of left and right lower side walls 17a extending downward from the left and right side walls 16c. Below the closed cross-sectional portion 16, an open cross-sectional portion 17 that opens downward is formed by the lower wall 16b and the left and right lower side walls 17a. A part (an upper portion) of the battery 3 can be detachably attached within the open cross-sectional portion 17.

A front cushion support portion 18 that supports the front end portion of a rear cushion 9b is provided at a corner portion sandwiched between the rear upper wall 16a2 of the main frame 12 and the lower portion of the seat frame 14 in a side view.

The pivot frame 13 is provided with a pivot portion 13a that supports the front end portion of the swing arm 9a so that the front end portion of the swing arm 9a can swing up and down. A cutout portion 13b is formed in the front portion of the pivot frame 13 to follow the outer shape of the drive unit 2 in a side view. The pivot frame 13 has a forward extension portion 13c that extends to the upper front side of the cutout portion 13b. A unit fixing portion 13d for fixing the drive unit 2 is provided at each of three locations, namely, the forward extension portion 13c and the upper and lower portions of the pivot portion 13a.

The swing arm 9a has an upwardly protruding V-shape in a side view. The front end portion of the swing arm 9a is connected to a pivot portion 13a via a pivot shaft 9c that extends in the left-right direction. The rear wheel 5 is supported by the rear end portion of the swing arm 9a. A rear cushion support portion 9d that supports the rear end portion of the rear cushion 9b is provided at an upwardly convex bent portion of the swing arm 9a.

The drive unit 2 has an elliptical appearance in a side view and is disposed such that the major axis of the elliptical shape is aligned with the inclination of the main frame 12. The drive unit 2 is supported by a pivot frame 13 from the upper end portion to the rear end portion thereof. The left and right end portions of a pedal crankshaft 2a protrude from both the left and right sides of the lower portion of the drive unit 2. A pair of left and right pedal cranks 2b are attached to the left and right end portions of the pedal crankshaft 2a, respectively.

Although not shown, a drive sprocket is provided on the right pedal crank 2b to be integrally rotatable therewith. Driven sprockets for gear shift are provided on the right side of a hub portion of the rear wheel 5. A drive chain is wound around the drive sprocket and any one of the driven sprockets. A transmission that changes a winding position of the drive chain is provided on the right side of the rear wheel 5.

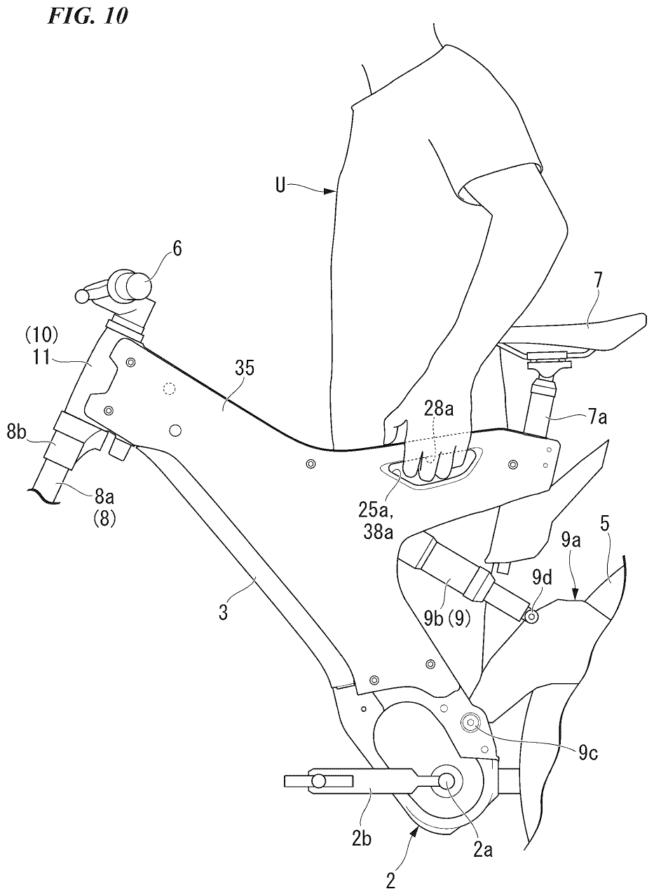

As shown in FIG. 10, in the case of the bicycle 1, a user U who has dismounted from the bicycle may lift the vehicle body and carry the bicycle.

In the embodiment, the following frame structure is applied to make it easier for the user U who has dismounted from the bicycle to lift the vehicle body and carry the bicycle.

In other words, the frame structure of the embodiment has a through hole 25a formed in the seat frame 14 above the main frame 12 for the user U to place his/her hand therein, and a part of the vehicle body frame 10 (the seat frame 14) made of a metal to be used as a handle. As a result, a handle that has high strength and gripping performance can be formed in the upper portion of the seat frame 14.

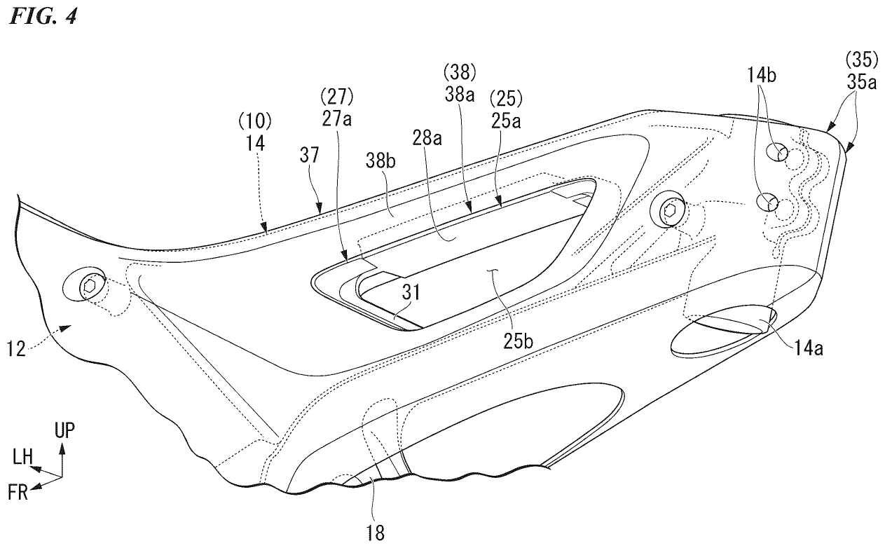

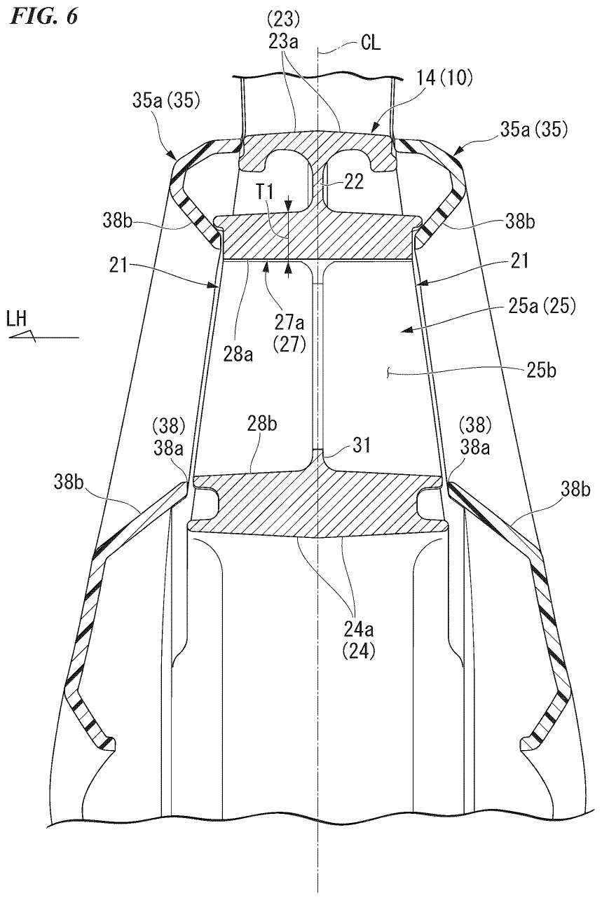

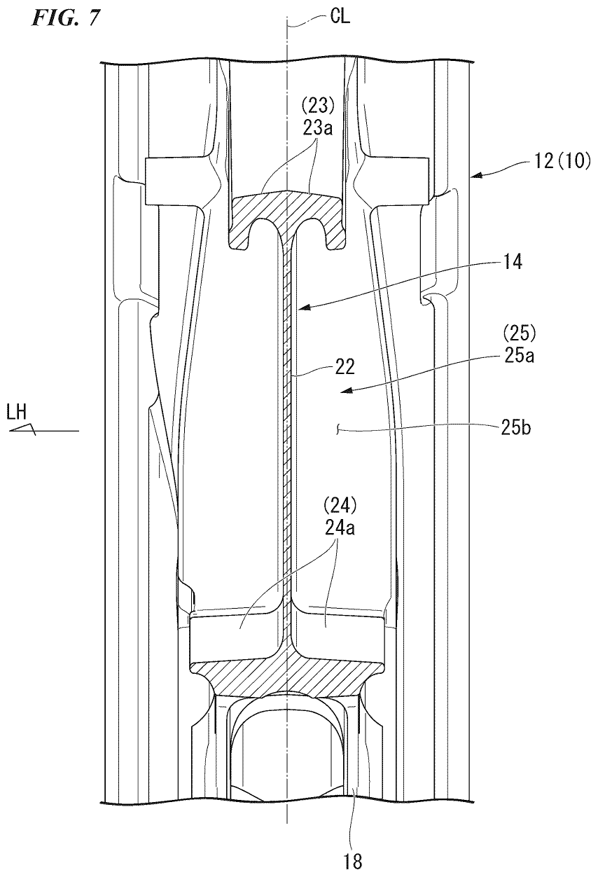

Referring also to FIGS. 2 to 7, the seat frame 14 includes an open cross-sectional portion 21 that extends obliquely rearward and upward from the main frame 12. The open cross-sectional portion 21 includes a flat central plate portion 22 disposed in the center in the left-right direction, and upper and lower wall portions 23 and 24 provided along the upper and lower edges of the central plate portion 22 with a specified left-right width. The open cross-sectional portion 21 is formed on each of the left and right sides of the central plate portion 22 and extends rearward and downward from the upper portion of the main frame 12 while having a cross-sectional shape that opens outward in the left-right direction,. The open cross-sectional portion 21 extends in the front-rear direction, thereby reducing the weight of the seat frame 14. The seat frame 14 is reinforced with appropriate ribs to ensure adequate rigidity while forming the through hole 25a therein for the user to grip the seat frame 14.

The upper wall portion 23 is formed by integrating a pair of left and right upper edge ribs 23a that extend outward in the left-right direction from the upper edge of the central plate portion 22. The lower wall portion 24 is formed by integrating a pair of left and right lower edge ribs 24a that extend outward in the left-right direction from the lower edge of the central plate portion 22. The upper and lower edge ribs 23a and 24a correspond to frame outer peripheral ribs that follow the outer peripheral edge of the seat frame 14 in a side view. The upper wall portion 23 has substantially the same left-right width as the front upper wall 16a1 of the closed cross-sectional portion 16 of the main frame 12 and is connected to the front upper wall 16a1 via an upper arc portion 23b. The lower wall portion 24 has substantially the same left-right width as the rear upper wall 16a2 of the closed cross-sectional portion 16 of the main frame 12 and is connected to the rear upper wall 16a2 via a lower arc portion 24b.

In a side view, the front portion of the upper edge (the upper wall portion 23) of the seat frame 14 curves forward and upward to form the upper arc portion 23b and is joined to the front portion (the front upper wall 16a1) of the upper edge of the main frame 12 via the upper arc portion 23b. In a side view, the front portion of the lower edge (the lower wall portion 24) of the seat frame 14 curves forward and downward to form the lower arc portion 24b and is joined to the rear portion (the rear upper wall 16a2) of the upper edge of the main frame 12 via the upper arc portion 24b.

In a side view, the upper and lower edges (the upper and lower wall portions 23 and 24) of the seat frame 14 which extend rearward and upward are formed to be substantially parallel to each other. The rear portion of the upper wall portion 23 forms a rear upper inclined wall portion 23c that is inclined rearward and downward via a bent portion. The rear end portions of the upper and lower wall portions 23 and 24 are connected to the upper and lower portions of a clamp pipe 14a, respectively. The clamp pipe 14a has a cylindrical shape that extends in the vertical direction, and a central axis C1 of the clamp pipe 14a is inclined rearward with respect to the vertical direction.

Referring to FIG. 1, a cylindrical seat post 7a is inserted into the clamp pipe 14a. The seat post 7a is fixed to and held by the clamp pipe 14a by tightening a pair of clamp bolts 14b. A seat 7 (a saddle) is supported on the upper end portion of the seat post 7a.

Referring to FIG. 3, in a side view, the through hole 25a forms an upper edge 26a that is substantially parallel to the upper edge (the upper wall portion 23) of the seat frame 14 which extends rearward and upward, a lower edge 26b that is substantially parallel to the lower edge (the lower wall portion 24) of the seat frame 14 which extends rearward and upward, a front edge 26c that spans between the front ends of the upper and lower edges 26a and 26b, and a rear edge 26d that spans between the rear ends of the upper and lower edges 26a and 26b. The upper edge 26a is longer in the front-rear direction than the lower edge 26b. The front edge 26c is inclined such that the lower side is positioned further rearward, and the rear edge 26d is inclined such that the lower side is positioned further forward. The through hole 25a has a trapezoidal shape in which a portion on a side of the lower edge 26b is narrow in a side view. An arc shape that connects adjacent edges is formed at each of four corners of the through hole 25a in a shape in a side view.

In a side view, the vertical width of the seat frame 14 is a width between the upper and lower edges 26a and 26b, and the front-rear width of the seat frame 14 is a width between the rear upper edge of the main frame 12 and the front edge of the clamp pipe 14a. In the seat frame 14, the through hole 25a that passes through a region within the front-rear width and the vertical width of the seat frame 14 in the left-right direction in a side view is formed. A portion of the seat frame 14 which forms the through hole 25a is referred to as a through hole forming portion 25. In the through hole 25a, a hole internal space 25b surrounded by the upper and lower edges 26a and 26b and the front and rear edges 26c and 26d in a side view is formed.

The hole internal space 25b is a space formed within the left-right width of the seat frame 14.

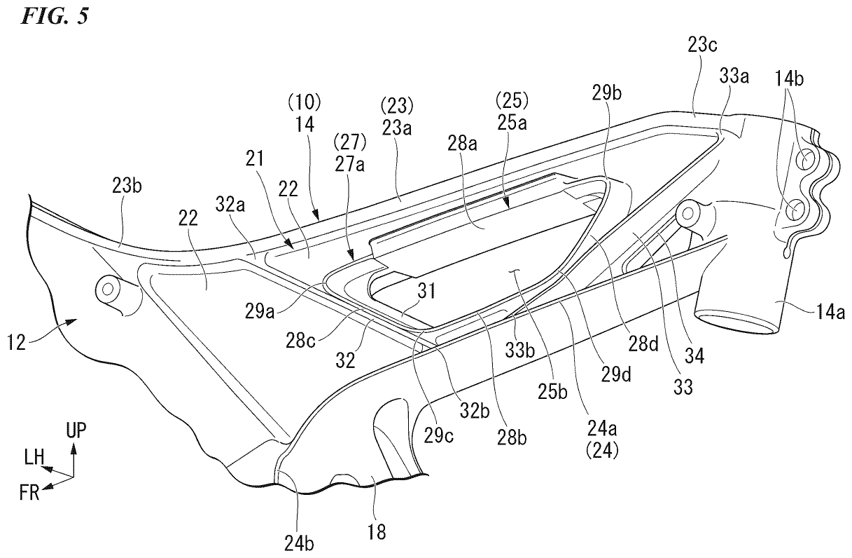

Referring to FIGS. 5 to 7, the through hole forming portion 25 includes an inner peripheral wall 27 that surrounds the hole internal space 25b of the through hole 25a over the entire periphery of the through hole 25a. The inner peripheral wall 27 is formed by integrating a pair of left and right peripheral wall ribs 27a that extend outward in the left-right direction from the peripheral edge of the through hole 25a. The inner peripheral wall 27 functions as a partition wall that separates the hole internal space 25b from various vehicle components (the rear cushion 9b, the seat post 7a, and the like) around the seat frame 14. As a result, when a user who has dismounted from the bicycle passes his or her fingers through the through hole 25a, the fingers do not come into contact with the surrounding components.

Hereinafter, in the inner peripheral wall 27, a portion that follows the upper edge of the through hole 25a in a side view is referred to as an upper surface portion (a grip portion) 28a, a portion that follows the lower edge of the through hole 25a in a side view is referred to as a lower surface portion 28b, a portion that follows the front edge of the through hole 25a in a side view is referred to as a front surface portion 28c, and a portion that follows the rear edge of the through hole 25a in a side view is referred to as a rear surface portion 28d. In addition, in the inner peripheral wall 27, portions that follow the arc shapes of the four corners of the through hole 25a in a side view are referred to as a front upper arc portion 29a, a rear upper arc portion 29b, a front lower arc portion 29c, and a rear lower arc portion 29d.

The upper surface portion 28a, the lower surface portion 28b, the front surface portion 28c, and the rear surface portion 28d are each formed into a flat shape extending in the left-right direction. In the embodiment, a flat shape may be a planar shape or have a slight curvature in a side view or in a cross-sectional view (see the drawings).

The seat frame 14 is formed such that its left-right width increases from its upper edge side toward its lower edge side. Therefore, the upper surface portion 28a is formed to be narrower in left-right width than the lower surface portion 28b, and the front surface portion 28c and the rear surface portion 28d are formed such that their left-right widths become narrower toward the upper side.

The upper surface portion 28a is formed in a flat shape that extends in the front-rear direction while having a substantially constant left-right width.

In this way, since the upper surface portion 28a that follows the upper edge of the through hole 25a in the seat frame 14 is formed in a flat shape extending in the left-right direction and the front-rear direction, even when a user places his or her fingers that have passed through the through hole 25a on the upper surface portion 28a and uses the upper portion of the seat frame 14 as a handle to lift the vehicle body frame 10 and ultimately the vehicle, the burden on the fingers is curbed, making it easier to lift the vehicle. Since the through hole forming portion 25 has the inner peripheral wall 27 that surrounds the hole internal space 25b over the entire periphery of the through hole 25a, fingers that have passed through the through hole 25a do not come into contact with the surrounding components, thereby preventing finger movement from being hindered or the fingers from becoming dirty.

The upper surface portion 28a is formed to be thicker than other portions of each of the peripheral wall ribs 27a. That is, the upper surface portion 28a is formed to have a greater thickness in the vertical direction than other portions, thereby ensuring the strength and rigidity against the load when the vehicle is lifted. The through hole forming portion 25 includes an inner peripheral rib 31 that protrudes from a portion of the inner peripheral wall 27 other than the upper surface portion toward the inside of the through hole 25a. Since the inner peripheral rib 31 is provided in a portion of the through hole 25a other than the upper surface portion, the strength and rigidity around the through hole 25a are increased while the impact on the hand is curbed when the hand is placed on the upper surface portion 28a to lift the vehicle.

Here, at least the seat frame 14 of the vehicle body frame 10 is formed by casting or forging by splitting a mold in the left-right direction. In the embodiment, the entire vehicle body frame 10 is integrally formed of the same material, but, for example, the seat frame 14 may be formed separately from the other portions and integrally coupled to the other portions by welding, fastening, or the like. The upper and lower edge ribs, the peripheral wall rib 27a, and a connecting rib, which will be described below, of the seat frame 14 extend in the left-right direction (a direction in which a mold is split).

The seat frame 14 is provided with a connecting rib that extends between a plurality of rib connecting portions 32a, 32b, 33a, and 33b that are provided on the frame outer peripheral ribs. The connecting ribs includes a front connecting rib 32 and a rear connecting rib 33.

The front connecting rib 32 linearly extends to be inclined such that the lower side is positioned further rearward between the rib connecting portion 32a in front of the upper arc portion 23b of each of the upper edge ribs 23a and the rib connecting portion 32b in front of the lower arc portion 24b of each of the lower edge ribs 24a. The front connecting rib 32 is disposed to be in contact with a portion of the peripheral wall rib 27a which forms the front surface portion 28c and is integrated therewith. The front connecting rib 32 also serves as a rib that connects the upper edge rib 23a and the lower edge rib 24a to the peripheral wall rib 27a.

The rear connecting rib 33 linearly extends to be inclined such that the lower side is positioned further forward between the rib connecting portion 33a at the rear end portion (a rear end portion of a rear upper inclined edge) of the upper edge rib 23a and the rib connecting portion 33b at the middle portion of the lower edge rib 24a in the front-rear direction. The rear connecting rib 33 is disposed to be in contact with and integrated with the rear lower arc portion 29d of the peripheral wall rib 27a. The rear connecting rib 33 also serves as a rib that connects the upper edge rib 23a and the lower edge rib 24a to the peripheral wall rib 27a. For example, a second through hole 34 is formed between the rear connecting rib 33 and the lower edge rib 24a. The seat frame 14 has a cross-sectional structure that opens outward in the left-right direction, but is reinforced with ribs as appropriate. The strength and rigidity of the seat frame 14 can be easily adjusted by changing the number and arrangement of the ribs. Since the seat frame 14 is covered with the frame cover 35, the impact on the appearance is curbed while the ribs are provided with functional priority.

Referring to FIGS. 2, 4 and 6, the frame cover 35 includes a pair of left and right cover members 35a that cover the vehicle body frame 10 from the outside in the left-right direction.

The cover member 35a integrally includes a main frame cover portion 36 that covers the main frame 12 from the outside in the left-right direction and a seat frame cover portion 37 that covers the seat frame 14 from the outside in the left-right direction.

The seat frame cover portion 37 includes a cover through hole forming portion 38 that forms a cover through hole 38a that overlaps the through hole 25a of the seat frame 14 in a side view. Since the cover member is integrally made, the design can be improved even in a case in which the vehicle body frame and the seat frame are formed separately.

The cover through hole forming portion 38 includes an inclined portion 38b that is inclined from a side of the through hole 25a of the seat frame 14 toward the outer side surface of the cover member 35a on the outer side in the left-right direction so as to be widened with respect to the through hole 25a in a side view toward the outer side in the left-right direction. As a result, when the hand is to be placed in the through hole 25a from the outside in the left-right direction, the hand is guided by the inclined portion 38b, making it easier to pass the hand through the through hole 25a. This also has the same aspect as chamfering the outer side in the left-right direction of the upper surface portion 28a of the seat frame 14, making the seat frame 14 become comfortable in the hand when the seat frame 14 is gripped.

In the embodiment, the upper surface portion 28a is formed by the seat frame 14, and this upper surface portion 28a is exposed to the hole internal space 25b, but the present invention is not limited to this configuration.

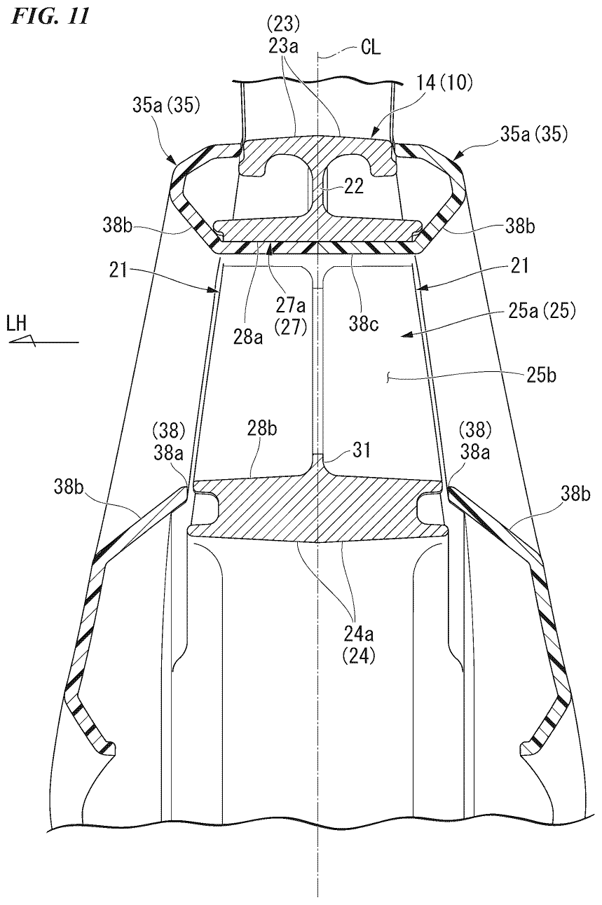

For example, as shown in FIG. 11, the cover through hole forming portion 38 may include an upper surface cover portion 38c that covers the upper surface portion 28a of the seat frame 14. Since the upper surface portion 28a made of a metal is covered with the upper surface cover portion 38c made of a resin, when the seat frame 14 is gripped, the touch can be made smooth.

Furthermore, as shown in FIG. 11, the upper surface portion 28a may be formed by only the frame cover 35 (only the upper surface cover portion 38c). In other words, it is sufficient that the upper surface portion 28a is formed by at least one of the seat frame 14 and the frame cover 35. The aspect of the upper surface portion 28a can be appropriately set according to the requirements for the handle of the frame.

As described above, a frame structure in the above embodiment includes: a head pipe 11; a main frame 12 extending rearward from the head pipe 11; and a seat frame 14 disposed above the main frame 12 and supporting a seat 7, wherein the seat frame 14 includes a through hole forming portion 25 that forms a through hole 25a that passes through a region within a front-rear width and a vertical width of the seat frame 14 in a left-right direction in a side view, wherein the through hole forming portion 25 includes an inner peripheral wall 27 surrounding a hole internal space 25b of the through hole 25a over the entire periphery of the through hole 25a, and wherein an upper surface portion 28a of the inner peripheral wall 27 that follows an upper edge of the through hole 25a is formed in a flat shape extending in a front-rear direction.

According to this configuration, since the through hole 25a is formed in the seat frame 14 above the main frame and the upper surface portion 28a that follows the upper edge of the through hole 25a in the inner peripheral wall 27 surrounding the hole internal space 25b of the through hole 25a is formed in a flat shape extending in the front-rear direction, a handle for gripping the seat frame 14 by placing the hand on the upper surface portion 28a of the inner peripheral wall 27 of the through hole 25a can be formed in the seat frame 14. As a result, it is possible to make it easier to lift and carry equipment such as a vehicle to which the frame structure is applied. Since the through hole forming portion 25 has the inner peripheral wall 27 that surrounds the hole internal space 25b of the through hole 25a over the entire periphery of the through hole 25a, the hole internal space 25b is separated from the structural components around the seat frame, and the hand that passes through the through hole 25a does not come into contact with the components around the frame and have its movement hindered, thereby making it easier to grip the seat frame 14 and preventing the hand from getting dirty.

In the above frame structure, the inner peripheral wall 27 is formed by a peripheral wall rib 27a extending in the left-right direction in a peripheral edge of the through hole 25a.

According to this configuration, since the inner peripheral wall 27 is formed by the peripheral wall rib 27a extending in the left-right direction in the peripheral edge of the through hole 25a, it is possible to achieve a structure in which the thickness in the left-right direction is reduced on the outer peripheral side of the peripheral wall rib 27a, and the weight of the seat frame 14 can be reduced compared to a case in which the entire seat frame 14 has the same thickness as the inner peripheral wall 27.

In the above frame structure, a portion of the peripheral wall rib 27a that forms the upper surface portion 28a is formed to be thicker than a portion of the peripheral wall rib 27a that forms another portion.

According to this configuration, since the portion of the peripheral wall rib 27a that forms the upper surface portion 28a is formed to be thick, it is possible to increase the strength and rigidity of the upper surface portion 28a which is subjected to the greatest load when a user grips the upper portion of the seat frame 14 to lift the vehicle. Since the portions that form the other portions except for the upper surface portion 28a are formed to be thin, the weight of the seat frame 14 can be reduced.

In the above frame structure, the through hole forming portion 25 includes an inner peripheral rib 31 that extends from the peripheral wall rib 27a toward an inside of the through hole 25a at a portion of the peripheral edge of the through hole 25a other than the upper surface portion 28a.

According to this configuration, since the inner peripheral rib 31 is provided in a portion of the through hole 25a other than the upper surface portion 28a, the strength and rigidity around the through hole 25a can be increased while the impact on the hand is curbed when the hand is placed on the upper surface portion 28a to grip the upper portion of the seat frame 14.

In the above frame structure, the seat frame 14 includes frame outer peripheral ribs (upper and lower edge ribs 23a and 24a) that follow the outer peripheral edge in a side view, and connecting ribs (a front connecting rib 32 and a rear connecting rib 33) that connect the peripheral wall rib 27a and the frame outer peripheral ribs.

According to this configuration, since the frame outer peripheral ribs that follow the outer peripheral edge of the seat frame 14 and the peripheral wall rib 27a that follows the peripheral edge of the through hole 25a are connected by the connecting ribs 32 and 33, the peripheral wall rib 27a can be reinforced and the strength and rigidity around the through hole 25a can be increased.

In the above frame structure, the frame outer peripheral ribs include a plurality of rib connecting portions 32a, 32b, 33a, and 33b that connect the connecting ribs, and the connecting ribs connect the plurality of rib connecting portions 32a, 32b, 33a, and 33b of the frame outer peripheral ribs.

According to this configuration, since a pair of the multiple rib connecting portions 32a, 32b, 33a, and 33b of the frame outer peripheral ribs are connected by the connecting ribs, the frame outer peripheral ribs can be reinforced, the strength and rigidity of the outer peripheral portion of the seat frame 14 can be increased, and the strength and rigidity around the through hole 25a can be increased.

In the above frame structure, the peripheral wall rib 27a, the frame outer peripheral ribs, and the connecting ribs extend in the left-right direction.

According to this configuration, since each rib of the seat frame 14 extends along the left-right direction, in a case in which the seat frame 14 having the through hole 25a in the left-right direction is formed by casting or forging, it is possible to easily form the seat frame 14 by splitting the mold in the left-right direction while increasing the strength and rigidity of the seat frame 14.

In the above frame structure, the main frame 12 extends while having a hollow closed cross-sectional portion 16, and the seat frame 14 extends from the main frame 12 while having an open cross-sectional portion 21 that opens outward in the left-right direction.

According to this configuration, since the main frame 12 has the hollow closed cross-sectional portion 16 and the seat frame 14 has the open cross-sectional portion 21 that opens outward in the left-right direction, it is possible to reduce the weight of the entire vehicle body frame 10. In addition, since the main frame 12 has the closed cross-sectional portion 16, it is possible to ensure strength and rigidity. In addition, since the seat frame 14 has the open cross-sectional portion 21, it is possible to achieve weight reduction and ease of manufacture. In addition, it is possible to ensure moderate strength and rigidity through the arrangement of the ribs.

The above frame structure further includes a cover member 35a for covering the seat frame 14 from outside in the left-right direction.

According to this configuration, since the seat frame 14 is covered with the cover member 35a from the outside in the left-right direction, it is possible to protect the seat frame 14 and improve the appearance.

In the above frame structure, the cover member 35a includes a cover through hole forming portion 38 that forms a cover through hole 38a that overlaps the through hole 25a of the seat frame 14 in a side view, and wherein the cover through hole forming portion 38 includes an inclined portion 38b that is inclined from a side of the through hole 25a of the seat frame 14 toward an outer side surface of the cover member 35a on an outer side in the left-right direction so as to be widened with respect to the through hole 25a in a side view toward the outer side in the left-right direction.

According to this configuration, since the cover through hole forming portion 38 is provided with the inclined portion 38b that is inclined so as to be widened with respect to the through hole 25a toward the outer side in the left-right direction, when the hand is attempted to be placed into the through hole 25a from the outside in the left-right direction, the hand is guided by the inclined portion 38b, making it easier to pass the hand through the through hole 25a, and making it easier to grip the upper portion of the seat frame 14.

As shown in the figure, in the above frame structure, the cover member 35a may include a cover through hole forming portion 38 that forms a cover through hole 38a that overlaps the through hole 25a of the seat frame 14 in a side view, and the cover through hole forming portion 38 may include an upper surface cover portion 38c that covers the upper surface portion 28a of the seat frame 14.

According to this configuration, since the cover member 35a of the seat frame 14 covers the upper surface portion 28a of the seat frame 14, in a case in which the seat frame 14 is made of a metal and the cover member 35a is made of a resin, the feeling on a side of the upper surface portion is softened, making it easier to grip the upper portion of the seat frame 14 by placing the hand on a side of the upper surface 28a.

In the above frame structure, the upper surface portion 28a of the inner peripheral wall 27 that follows an upper edge of the through hole 25a may be formed in a flat shape extending in a front-rear direction by at least one of the seat frame 14 and the cover member 35a.

According to this configuration, since the upper surface portion 28a of the inner peripheral wall 27 is formed by at least one of the seat frame 14 and the cover member 35a, it is possible to more easily meet the requirements (the strength and rigidity, the appearance, the feeling, the ease of manufacture, and the like) required when a handle is provided.

The present invention is not limited to the above embodiment. For example, the seat frame 14 in the embodiment is formed integrally with the main frame 12, but the seat frame 14 may be configured as a separate body from the main frame 12 to be connected to the main frame 12 by bolting or the like. The upper surface portion 28a of the through hole forming portion 25 only has to extend in the front-rear direction overall and only has to be free of extreme unevenness or corners, and may have, for example, a wavy shape (an uneven portion) of less than a specified height that follows the shape of the fingers. In this case, the seat frame 14 can be more easily gripped.

The frame structure of the present embodiment is applied to a bicycle as a vehicle that can be lifted by a user, but may also be applied to a saddle-ride type vehicle such as a motorcycle. The saddle-ride type vehicle includes all vehicles in which a driver straddles the vehicle body, including a motorcycle (including a bicycle with a prime mover or a scooter type vehicle) as well as a three-wheeled vehicle (including a vehicle having one front wheel and two rear wheels as well as a vehicle having two front wheels and one rear wheel) or a four-wheeled vehicle (a four-wheeled buggy or the like). The saddle-ride type vehicle may be applied to a vehicle that includes an electric motor as a prime mover.

The configuration in the above-described embodiment is an example of the present invention, and various changes can be made without departing from the scope of the present invention, such as replacing the components of the embodiment with the known components.

### BRIEF DESCRIPTION OF THE REFERENCE SYMBOLS

1: Bicycle (vehicle)

7: Seat

7a: Seat post

10: Vehicle body frame

11: Head pipe

12: Main frame

13: Pivot frame

14: Seat frame

16: Closed cross-sectional portion

16a: Upper wall

16a1: Front upper wall

16a2: Rear upper wall

16b: Lower wall

16c: Left and right side walls

17: Open cross-sectional portion

17a: Lower side wall

21: Open cross-sectional portion

22: Central plate portion

23: Upper wall portion

23a: Upper edge rib (frame outer peripheral rib)

24: Lower wall portion

24a: Lower edge rib (frame outer peripheral rib)

25: Through hole forming portion

25a: Through hole

25b: Hole internal space

26a: Upper edge

26b: Lower edge

27: Inner peripheral wall

27a: Peripheral wall rib

28a: Upper surface portion (grip portion)

31: Inner peripheral rib

32: Front connecting rib (connecting rib)

33: Rear connecting rib (connecting rib)

32a, 32b, 33a, 33b: Rib connecting portion

35: Frame cover

35a: Cover member

38: Cover through hole forming portion

38a: Cover through hole

38b: Inclined portion

38c: Upper surface cover portion

1.-12. (canceled)

13. A frame structure comprising:
a head pipe;
a main frame extending rearward from the head pipe; and
a seat frame disposed above the main frame and supporting a seat,
wherein the seat frame includes a through hole that passes through a region within a front-rear width and a vertical width of the seat frame in a left-right direction in a side view, and
wherein a grip portion that follows an upper edge of the through hole is formed in a flat shape extending in a front-rear direction.

14. The frame structure according to claim 13, wherein the grip portion is formed in a plane shape extending in a vehicle width direction.

15. The frame structure according to claim 14, further comprising an inner peripheral wall surrounding a hole internal space of the through hole over the entire periphery of the through hole,
wherein the inner peripheral wall is formed by a peripheral wall rib extending in the left-right direction over the entire periphery of a peripheral edge of the through hole, and
wherein a portion of the peripheral wall rib that forms the grip portion is formed to be thicker than a portion of the peripheral wall rib that forms another portion.

16. The frame structure according to claim 15, wherein an inner peripheral rib that extends from the peripheral wall rib toward an inside of the through hole is provided at a portion of the peripheral edge of the through hole other than the grip portion.

17. The frame structure according to claim 15, further comprising connecting ribs connecting the peripheral wall rib and frame outer peripheral ribs.

18. The frame structure according to claim 16, further comprising connecting ribs connecting the peripheral wall rib and frame outer peripheral ribs.

19. The frame structure according to claim 17,
wherein the frame outer peripheral ribs include a plurality of rib connecting portions that connect the connecting ribs, and
wherein the connecting ribs connect the plurality of rib connecting portions of the frame outer peripheral ribs.

20. The frame structure according to claim 18,
wherein the frame outer peripheral ribs include a plurality of rib connecting portions that connect the connecting ribs, and
wherein the connecting ribs connect the plurality of rib connecting portions of the frame outer peripheral ribs.

21. The frame structure according to claim 19, wherein the peripheral wall rib, the frame outer peripheral ribs, and the connecting ribs extend in the left-right direction.

22. The frame structure according to claim 20, wherein the peripheral wall rib, the frame outer peripheral ribs, and the connecting ribs extend in the left-right direction.

23. The frame structure according to claim 13,
wherein the main frame extends while having a hollow closed cross-sectional portion, and
wherein the seat frame extends from the main frame while having an open cross-sectional portion that opens outward in the left-right direction.

24. The frame structure according to claim 13, further comprising a cover member for covering the seat frame from outside in the left-right direction.

25. The frame structure according to claim 24,
wherein the cover member includes a cover through hole forming portion that forms a cover through hole that overlaps the through hole of the seat frame in a side view, and
wherein the cover through hole forming portion includes an inclined portion that is inclined from a side of the through hole of the seat frame toward an outer side surface of the cover member on an outer side in the left-right direction so as to be widened with respect to the through hole in a side view toward the outer side in the left-right direction.

26. The frame structure according to claim 24,
wherein the cover member includes a cover through hole forming portion that forms a cover through hole that overlaps the through hole of the seat frame in a side view, and
wherein the cover through hole forming portion includes an upper surface cover portion that covers the grip portion of the seat frame.

27. The frame structure according to claim 25,
wherein the cover member includes a cover through hole forming portion that forms a cover through hole that overlaps the through hole of the seat frame in a side view, and
wherein the cover through hole forming portion includes an upper surface cover portion that covers the grip portion of the seat frame.

28. A frame structure comprising:
a head pipe;
a main frame extending rearward from the head pipe;
a seat frame disposed above the main frame and supporting a seat; and
a cover member for covering the seat frame from outside in a left-right direction,
wherein the seat frame includes a through hole forming portion that forms a through hole that passes through a region within a front-rear width and a vertical width of the seat frame in a left-right direction in a side view,
wherein the through hole forming portion includes an inner peripheral wall surrounding a hole internal space of the through hole over the entire periphery of the through hole, and
wherein a grip portion of the inner peripheral wall that follows an upper edge of the through hole is formed in a flat shape extending in a front-rear direction by at least one of the seat frame and the cover member.
